(19) United States
(12) Patent Application Publication
(10) Pub. No.: US 2006/0096862 A1
(43) Pub. Date: May 11, 2006

(54) Process analytic sensors for demanding applications

(76) Inventor: Barry W. Benton, Orange, CA (US)

Correspondence Address: Christopher R. Christenson;WESTMAN, CHAMPLIN & KELLY, P.A., International Centre, Suite 1400, 900 Second Avenue South, Minneapolis, MN, 55402-3319, US

(21) Appl. No.: 11/268,767

(22) Filed: Nov. 7, 2005

Related U.S. Application Data
(60) Provisional application No. 60/625,933, filed on Nov. 8, 2004.

(51) Int. Cl. G01N 27/26

(52) U.S. Cl. 204/431

(57) ABSTRACT

An insertion-type process analytic sensor has a distal end that is configured to couple to a process and a proximal end that is configured to couple to the ambient environment. The sensor is constructed from materials that reduce the occurrence of vapor within the sensor as well as facilitate its venting through the proximal end. Additionally, aspects of the invention include selecting materials for internal components of the insertion-type process analytic sensor that provide little or no extractables even when vapor is present within the sensor.

### CROSS-REFERENCE TO RELATED APPLICATION

The present application is based on and claims the benefit of U.S. provisional patent application Ser. No. 60/625,933, filed Nov. 8, 2004, the content of which is hereby incorporated by reference in its entirety.

### BACKGROUND OF THE INVENTION

Process analytic sensors are generally configured to couple to a given process, such as an oil refining process or a pharmaceutical manufacturing process, and provide an analytical output relative to the process. Examples of such analytical outputs include, but are not limited to: measurement to pH; measurement of oxidation reduction potential; selective ion measurement; measurement of dissolved gases, such as dissolved oxygen; and measurement of pressure. These analytical measurements can then be provided to a control system such that process control can be effected and/or adjusted based upon the analytic measurement. Such sensors are generally continuously, or substantially continuously, exposed to the process medium.

One particular type of process analytic sensor is known as an insertion-type process analytic sensor. An insertion-type process analytic sensor is generally configured to couple to a given process by passing through a vessel wall and mounting thereto. Accordingly, an insertion-type process analytic sensor has a distal end that is configured for exposure to the process and a proximal end that is disposed on an opposite side of the vessel wall from the distal end. Generally, insertion-type process analytic sensors are mounted directly to the vessel itself. The vessel may be a pipe, a container, or any other structure that contains a process fluid of interest.

Process analysis is very demanding. On the one hand, industry requires higher and higher accuracy and precision with respect to process analytical measurements. On the other hand, the processes to which such sensors are exposed are becoming more demanding in terms of pressure and temperature. A failure mode that is becoming increasingly common to process analytic sensor, as both the temperature and pressure of industrial requirements rise, is the loss of signal integrity due to decreased signal isolation. Once signal integrity is lost, it is necessary to replace or repair the process analytic sensor, which can potentially require that the entire process be taken offline. Accordingly, providing process analytic sensors, particularly of the insertion-type, that are more robust and better able to withstand the increased temperatures and pressures of the processes to which they are exposed, will benefit the process analytic industries.

### SUMMARY OF THE INVENTION

An insertion-type process analytic sensor has a distal end that is configured to couple to a process and a proximal end that is configured to couple to the ambient environment. The sensor is constructed from materials that reduce the occurrence of vapor within the sensor as well as facilitate its venting through the proximal end. Additionally, aspects of the invention include selecting materials for internal components of the insertion-type process analytic sensor that provide little or no extractables even when vapor is present within the sensor.

### BRIEF DESCRIPTION OF THE DRAWINGS

FIG. 1 is a diagrammatic view of a process analytic sensor coupled to a process and to a process analyzer.

FIG. 2 is a diagrammatic view of a commercially available pH sensor in accordance with the prior art.

FIG. 3 is a cross sectional diagrammatic view of process analytic sensor 100 in accordance with an embodiment of the present invention.

### DETAILED DESCRIPTION OF ILLUSTRATIVE EMBODIMENTS

Many embodiments of the present invention arise based upon the unique understanding of the manner in which degradation of process analytic sensors occurs in demanding environments. Accordingly, before describing various process analytic sensor constructions in accordance with embodiments of the present invention, it is first useful to address a failure mode currently experienced in process analytic sensors.

A principal mechanism in the failure process of analytic sensors is the accumulation of electrolytes within the sensor construction. These electrolytes both reduce signal strength through decreased resistivity between the signal and instrument common, and inject spurious voltages and currents through galvanic activity. In a sensor of uncompromised mechanical integrity, these electrolytes are generally comprised of vapor from the high temperature and/or high volatility process liquid being analyzed. These vapors permeate the mechanical components of the sensor housing. As the interior of the sensor housing is usually cooler than the sample, the vapor condenses within the sensor. Sensor construction polymers can sometimes generate amines, phenols, aldehydes, alcohols and other organics that are soluble by the vapor and/or condensate resulting therefrom. The internal wiring within the sensor can sometimes also generate soluble metallic ions. The electrolyte can permeate the polymers within a sensor with high moisture equilibrium, such as epoxies, commonly used to fill the voids within the sensor. Vapor also accumulates and migrates in and through the interfaces formed at unadhered component and filler material surfaces.

In order to better describe the problems observed above, a specific example of a pH sensor monitoring an aqueous solution will be provided. For example, consider a plastic housing pH sensor monitoring an aqueous solution at 105° Centigrade. Water vapor moves through the polyphenylene ether (PPE) or polyphenylene oxide (PPO) housing, the ethylene propylene o-rings sealing the reference, pH, and solution ground electrodes to the housing, and the epoxy filling the voids within the housing. The vapor scavenges sulfides from the plastic, peroxides from the o-rings, and amines from the epoxy filler. This condenses within the interfaces between the epoxy filler and the glass electrodes, the shrink sleeve insulation covering the wiring solder connections, the heavily plastisized vinyl wiring insulation, and the interior wall of the plastic housing. The condensate dissolves lead and tin ions from the solder connections at the electrodes, further increasing the conductivity of the condensate and creating galvanic potentials between the electrode connections within the sensor. This electrolyte even permeates the typical epoxy filling, at a rate increasing with temperature, until the epoxy becomes a significant conductor and voltage potential source. As the electrolyte becomes more concentrated and migrates further over time, the signal isolation between the pH electrode and the other electrodes and the temperature sensor will progressively decrease. Because the pH electrode signal typically has a source impedance of 100 megohms, a reduction of internal isolation from 10⁶ to 10⁵ megohms will noticeably reduce sensor performance. Further, a reduction to 10⁴ megohms causes the sensor to fail. Traditional materials and methods of construction are clearly not adequate for use as industrial process temperatures rise from 85° Celsius towards 135 and 150° Celsius.

Various embodiments of the present invention make use of this understanding of the mechanism by which process analytic sensors are susceptible to degradation and adjust or otherwise modify sensor construction materials in order to reduce such degradation.

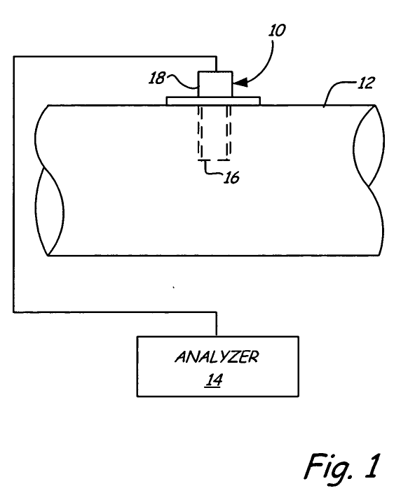

FIG. 1 is a diagrammatic view of a process analytic sensor 10 coupled to a process, illustrated diagrammatically as pipe 12 and a process analyzer 14. Process analytic sensor 10 is an insertion-type process analytic sensor having a distal end 16 and a proximal end 18. Distal end 16 is adapted for contact with process media within pipe 12 and provides an analytical indication relative to the process medium.

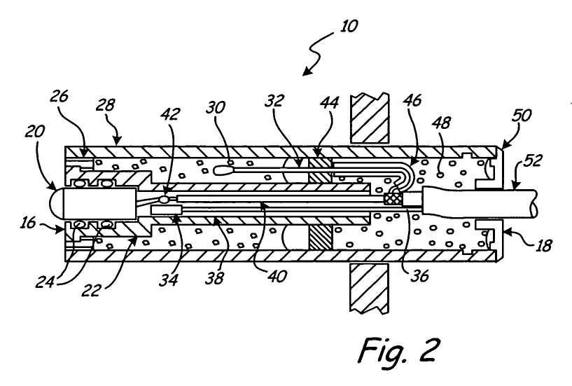

FIG. 2 is a diagrammatic view of a commercially available pH sensor in accordance with the prior art. Sensor 10 includes distal end 16 which is adapted for contact with the process media, and proximal end 18 which is disposed outside or away from the process media. Distal end 16 includes pH electrode 20, which is generally positioned within inner housing 22 and is sealed therein by inner housing to pH electrode sealing o-ring 24. O-rings 24 have traditionally been formed of ethylene propylene, with a relatively higher vapor permeability than materials inside the sensor. This vapor permeability of o-rings 24 has generally allowed water vapor from the hot reference distal end to permeate sensor 10. Sensor 10 also includes peripheral reference junction 26 disposed proximate pH electrode 20 with the distal end of inner housing 22 being interposed between pH electrode 20 and peripheral reference junction 26.

Sensor 10 includes a tubular plastic outer housing 28 that is formed of PPE (polyphenylene ether) or PPO (polyphenylene oxide) and is generally configured for exposure to the process fluids. Reference fill solution 30 is disposed within sensor housing 28 between sensor housing 28 and inner housing 22. Reference fill solution 30 constitutes an electrical half cell with silver/silver chloride reference wire 32 and peripheral reference junction 26. Silver/silver chloride reference wire 32 is actually a silver wire with a silver chloride coating disposed thereon. Sensor 10 also includes internal temperature sensor 34 that is disposed within inner housing 22. Temperature sensor 34 is coupled to cabling 36 by temperature sensor lead to cable wire solder connections 38. Electrode 20 is coupled to insulated copper wire 40 by lead tin solder joint 42. A rubber seal 44 with a relatively higher vapor permeability than other materials inside sensor 10 generally seals fill solution 30 of sensor 10 from proximal end 18. Silver/silver chloride reference wire 32 generally includes vinyl sleeving insulation 46 that abuts rubber seal 44. The interior of sensor 10 beyond rubber seal 44 and pH electrode 20, excepting the space occupied by fill solution 30, is generally filled with a cast-in-place epoxy insulation and mechanical back fill 48. Finally, a cable exit/dress cap 50 is provided at proximal end 18 to cover proximal end 18. Dress cap 50 includes an aperture allowing signal cable 52 to exit such that sensor 10 can be coupled to a suitable analyzer such as analyzer 14 (illustrated in FIG. 1).

Various embodiments of the present invention generally include insertion-type process analytic sensors having components formed of various materials that facilitate venting, or otherwise resist degradation. Various embodiments of process analytic sensor construction provide materials and configurations such that the distal, sampling end of the sensor has very low vapor permeability while the interior of the sensor has a relatively high vapor permeability, with a similarly high or greater vapor permeability out through the proximal, ambient environment end of the sensor. Additionally, only relatively low extractable materials are used in the interior construction of the process analytic sensor, thereby providing very low unreacted material residue. Further, such low, unreacted material residue is of a non-conductive and non-corrosive nature. The interior materials are preferably selected for mutual adhesion, ensuring the absence of unbonded interfaces. The resulting process analytic sensors in accordance with various embodiments of the present invention, suffer from relatively little or no accumulation of reactive electrolytes, as the process sample vapor, such as water vapor, entering the sensor through the distal, sensing, end, is quickly dissipated out the back of the sensor by the high vapor permeability materials before condensing into a solvent, and while the use of low extractable polymers obviates residual reactive solutes. The absence of unbonded interfaces eliminates spaces in which condensate and unreacted components can potentially accumulate, reside or migrate to the detriment of the insulation properties of the sensor internal construction. With little condensed vapor solvent, no or few unreacted material solutes, and relatively no interface spaces for accumulation or migration thereof, relatively no electrolyte will form, thereby preventing galvanic potentials and shorting between the various internal electrodes and wire connections as the sensor ages. This is believed to provide a process analytic sensor with relatively longer high-temperature life as the signal is not dissipated by deteriorating insulation properties of the internal construction.

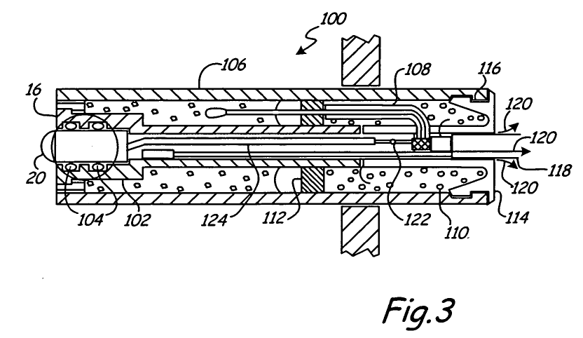

FIG. 3 is a cross sectional diagrammatic view of process analytic sensor 100 in accordance with an embodiment of the present invention. Sensor 100 bears some similarities to sensor 10 described with respect to FIG. 2. However, sensor 100 includes a number of elements that are formed of specific materials, and such elements are numbered differently in order illustrate the contrast. Sensor 100 includes pH electrode 20 disposed proximate distal end 16. While pH electrode 20 is sealed within inner housing 102 using o-rings 104, the o-rings 104 vapor permeability is now lower than material 110 inside the sensor with respect to material 48. Additionally, o-rings 104 and rubber seal 112 may be formed of a yet lower vapor permeability material such as perfluoronated rubber and/or Parylene coating to increase the vapor permeability differential. Additionally, inner housing 102 is formed of polyetheretherketone (PEEK) instead of the traditional materials such as polyphenylene oxide (PPO) and/or polyphenylene ether (PPE). Using polyetheretherketone for inner housing 102 eliminates one source of extractables because polyetheretherketone will source significantly lower extractables than prior materials used for inner housing 102. Additionally, outer housing 106 is preferably formed of a low vapor permeability, low extractable polymer, such as polypropylene or ethylenetetrafluoroethylene (ETFE) instead of PPE or PPO. FIG. 3 also illustrates that insulator 108 on the silver/silver chloride reference wire is formed by high purity platinum cure silicone tubing insulation instead of the traditional vinyl sleeving. The use of silicone rubber fill material and silicone tubing generates a synergy in that the tubing will bond intimately with the polymer silicone fill thereby forming a contiguous whole. This change reduces yet another source of extractables and increases the robustness of the sensor. Additionally, sensor 100 does not use cast in place epoxy, but instead uses vulcanized in place self-priming addition cure silicone 110 to fill the interior of inner housing 102, and to fill the space between the inner diameter of outer housing 106 and the outer diameter of inner housing 102 on the proximal side of rubber seal 112. Since cast in place epoxy was of adequate strength and rigidity to contain the various components within the outer housing 106 at high process temperatures and pressures, and vulcanized in place silicone 110 is relatively weak and flexible, end cap 114 is provided with a snap feature that engages an internal notch 116 within housing 106 for component retention. Signal cable 118 is provided with internal fibers that facilitate vapor venting thereby allowing vapors formed or otherwise present within sensor 100 to be vented as illustrated by lines 120. Another important distinction between sensor 100 and sensor 10 is the manner in which electrical connections are effected. Specifically, the lead solder connection between pH electrode 20 and signal cable 118 is illustrated at reference number 122 disposed on the proximal side of low vapor permeability rubber seal 112. Additionally, lead 124 is changed from being a portion of signal cable 118 to being a silver lead insulated with high purity platinum cure silicone tubing. This change also eliminates another potential source of extractables.

As can be seen with respect to FIG. 3, great care is given to vapor permeability and selection of materials based on the proclivity of such materials to generate extractables. Accordingly, where the electrodes pierce the housing, relatively lower vapor permeability elastomeric polymer adhesives or seals (typically EP rubber, profluorinated rubber and/or Parylene coated o-rings) prevent intrusion of the process into the sensor. The housing itself is formed of a low vapor permeability, low extractable polymer such as polypropylene or ethylenetetrafluoroethylene (ETFE). Any additional components within sensor 100 are also generally formed of low extractable material, such as glass, platinum, silver, polyetheretherketone, polypropylene, ETFE, or silicone. The critical electrode to cable connections are insulated and/or sealed with silicone rubber tubing and self priming, adhesive, low extractable, two part vulcanizing silicone rubber. Any spaces internal to the housing are filled with the same or similar silicone rubber. With the exception of the temperature sensor, the use of solder is restricted to the cable wiring connections, at the proximal end of the sensor housing. All electrode connections are made by extending the platinum, silver, or corrosion resistant solid metal wires unbroken from the electrode to the cable connections at the cable, proximal end of the sensor housing. The electrode and temperature sensor wires are insulated with silicone. The proximal end of sensor 100 is sealed to prevent liquid leakage into the housing from the cable exit. The housing cable end seals are formed of high vapor permeability (typically silicone) adhesives or seals. The cable itself utilizes a fibrous filler to facilitate venting of the high vapor permeability silicone filling the sensor housing. Where a cable is not used, a high vapor permeability but water-proof material, such as silicone, is placed at the proximal end of the sensor to facilitate venting to the atmosphere.

Accordingly, various embodiments of the present invention generally employ or provide low-extractable material and/or materials that may also facilitate venting vapor within the sensor to the atmosphere via the proximal end of the insertion-type process analytic sensor. The internal use of exclusively low extractable silicone rubber for electrode seals contacting the housing filling material, insulating all electrode leads, insulating all solder connections, and venting the sensor interior to atmosphere provides not only a high-purity internal environment for the process analytic sensor but also facilitates venting. Moreover, the use of a self priming, adhesive, low extractable solid (such as silicone rubber) filling the sensor and eliminating interface voids dramatically reduces the internal buildup of condensate and greatly restricts the availability of reactive ions. Accordingly, vapor entry from the typically hot and high pressure process near the distal end of sensor 100 is restricted by relatively lower vapor permeability materials. At the same time, venting of vapor from the interior of sensor 100 is facilitated by high vapor permeability materials communicating to the ambient environment at the cable (proximal) end of the sensor 100. Additionally, the high-purity internal components and filler introduce substantially no corrosive or conductive materials, thereby preventing damaging and/or spurious galvanic currents within the sensor. This systemic selection and placement of materials reduces vapor entry, vapor and condensate retention, electrolyte constituents, and electrolyte sites and transport, thereby better isolating electrode signals.

Conventional glass membrane and reference junction impedance sensor diagnostics are becoming less effective with rising process sample temperatures. For example, at 105° Celsius, the glass membrane impedance is only a couple of megohms, but a heat aged membrane may exceed 10³ megohms when removed from the process sample for room temperature sensor evaluation. At high temperature the membrane impedance is too low to test and gives no indication of the possible very high room temperature impedance of the pH membrane but will prevent the detection at high temperature of a cracked pH membrane. Diagnostics of the reference electrode are even more variable with temperature and age. Because a very aged, high impedance pH glass membrane may still be effective at high temperature, another diagnostic is needed. In high temperature applications, a common failure mode is the loss of signal isolation, as discussed above, providing reliable isolation at high temperature not only extends sensor life, but the required materials and construction also allow the impedance between the various electrodes and the temperature sensor (not in contact with the process sample) to be an indicator of sensor condition.

Epoxies commonly used for sensor housing void filling insulation lose several orders of impedance magnitude at high temperature, even when new and dry. So, this impedance measurement cannot be used as an indication of detrimental electrolyte buildup within the sensor. Silicone polymer filling of the electrical connection portion of the sensor housing void suffers little impedance reduction with increased temperature. Accordingly, a loss of impedance between the temperature sensor and any electrode indicates failing sensor integrity within the vicinity of that electrode. An instrument or transmitter can thus detect not only sensor failure, but impeding failure, and the importance of the failure. For instance, a 10² megohm reduction between the temperature sensor and the pH electrode would be serious and could be predicted by monitoring the steady decrease in insulation resistance over time. A similar reduction between the temperature sensor and the solution ground would be insignificant to the operation of the sensor, but would be an indicator of decreased sensor integrity. The pH electrode has a typical source impedance of 10² megohms, while the solution ground has a source impedance of ohms. A diagnostic that reliably indicated sensor integrity while in service at high temperature could reduce or eliminate the need for removal of the sensor for room evaluation, which it would very possibly fail due to high pH membrane impedance, even though the sensor was working well at high temperature due to the reduction in membrane impedance with temperature. Significantly reducing the vapor and condensate (solvent) concentration in the sensor, reducing the availability of reactive ions (solutes) and transport thereof via component interfaces, and replacing poor insulation fillers, such as epoxy, with exceptionally good insulation fillers, such as silicone, will lengthen sensor life and allow new, high temperature diagnostics.

Embodiments of the present invention also provide manufacturing benefits. An epoxy filled process analytic sensor cannot be tested until the epoxy has cured. This is because the uncured epoxy acts as a low impedance, electrolyte shorting out the signal. As the epoxy cures the sensor will test better and better. Thus a low signal sensor may be scraped when the only problem is poorly mixed epoxy that cures more slowly than expected and may have yielded a “good” sensor in a few days. This creates both scrap losses and manufacturing delays. A scrap sensor cannot usually be rebuilt due to the hard epoxy. A sensor with two part vulcanizing silicone polymer can be tested immediately after assembly and readily rebuilt if necessary.

Although the present invention has been described with reference to preferred embodiments, workers skilled in the art will recognize that changes may be made in form and detail without departing from the spirit and scope of the invention.

What is claimed is:

1. An insertion-type process analytic sensor having a distal end configured for exposure to a process fluid, and a proximal end configured for exposure to an ambient environment, the sensor comprising:
an outer housing extending between the distal end and the proximal end;
at least one sensing electrode disposed proximate the distal end, the at least one sensing electrode having an electrical characteristic that varies in response to an analytical quantity of the process fluid; and
wherein the distal end of the sensor has a relatively lower vapor permeability than the proximal end.

2. The sensor of claim 1, and further comprising a high vapor permeability fill material disposed in the proximal end of the housing.

3. The sensor of claim 2, wherein the fill material is a low extractable fill material.

4. The sensor of claim 3, wherein the fill material is silicone rubber.

5. The sensor of claim 1, and further comprising an internal housing disposed within the outer housing, wherein the internal housing is formed of polyetheretherketone (PEEK).

6. The sensor of claim 1, wherein the outer housing is formed of ethylenetetrafluoroethylene.

7. The sensor of claim 1, and further comprising a signal cable disposed within the fill material and operably coupled to at least one sensing electrode by a solder junction disposed on a proximal side of an internal seal within the housing.

8. The sensor of claim 7, wherein the signal cable contains a fibrous core material to vent vapor along the signal cable.

9. The sensor of claim 7, wherein the signal cable is coupled to a silver/silver chloride reference wire insulated with silicone rubber.

10. The sensor of claim 7, wherein the at least one sensing electrode is coupled to the signal cable through at least one conductor that is insulated with silicone rubber.

11. The sensor of claim 1, and further comprising an endcap mechanically engaged with internal surface of the outer housing.

12. The sensor of claim 1, wherein the outer housing is formed of polypropylene.

13. An insertion-type process analytic sensor having a distal end configured for exposure to a process fluid, and a proximal end configured for exposure to an ambient environment, the sensor comprising:
an outer housing extending between the distal end and the proximal end;
at least one sensing electrode disposed proximate the distal end, at least one sensing electrode having an electrical characteristic that varies in response to an analytical quantity of the process fluid; and
wherein the proximal end of the outer housing is filled with a high vapor permeability fill material.

14. The sensor of claim 13, wherein the high vapor permeability fill material is a low extractable material.

15. The sensor of claim 14, wherein the low extractable material is silicone rubber.

16. The sensor of claim 13, and further comprising a signal cable disposed within the fill material and operably coupled to at least one sensing electrode by a solder junction disposed on a proximal side of an internal seal within the housing.

17. The sensor of claim 16, wherein the signal cable contains a fibrous core material to vent vapor along the signal cable.

18. The sensor of claim 16, wherein the signal cable is coupled to a silver/silver chloride reference wire insulated with silicone rubber.

19. The sensor of claim 16, wherein the at least one sensing electrode is coupled to the signal cable through at least one conductor that is insulated with silicone rubber.

20. An insertion-type process analytic sensor having a distal end configured for exposure to a process fluid, and a proximal end configured for exposure to an ambient environment, the sensor comprising:
an outer housing extending between the distal end and the proximal end;
at least one sensing electrode disposed proximate the distal end, the at least one sensing electrode having an electrical characteristic that varies in response to an analytical quantity of the process fluid; and
means for venting vapor from the distal end of the sensor out through the proximal end of the sensor.

21. A method of diagnosing a process analytic sensor, the method comprising:
measuring an impedance between at least one electrode of the sensor and a temperature sensor disposed within the sensor; and
generating a diagnostic output based on the measured impedance.
